(19) United States
(12) Patent Application Publication
(10) Pub. No.: US 2016/0327704 A1
(43) Pub. Date: Nov. 10, 2016

(54) SPATIAL COLOR IMAGE DISPLAY DEVICE

(71) Applicant: E-LON OPTRONICS CO., LTD., New Taipei City (TW)

(72) Inventor: Ming-Tang YAO, New Taipei City (TW)

(21) Appl. No.: 14/704,087

(22) Filed: May 5, 2015

(51) Int. Cl. G02B 5/18; G02B 1/14; G02B 3/00

(52) U.S. Cl. CPC G02B 5/1842; G02B 3/0056; G02B 5/1814; G02B 1/14; G02B 5/1819

(57) ABSTRACT

A spatial color image display device including: a figure pattern layer, made of a transparent material and having at least one figure zone, each of the at least one figure zone being defined by an area of a geometric shape; and a microlens layer, located above the figure pattern layer and having a first surface, a second surface, and a plurality of microlenses disposed two-dimensionally on the second surface, the first surface contacting the figure pattern layer, each of the microlenses having a cross section region on the second surface, and the cross section region being similar to the figure zone with a size ratio of 1:(n+r) or (n+r):1, n being a positive integer and 0<r<0.2 or −0.2<r<0; wherein each of the at least one figure zone has therein a figure pattern formed by a plurality of gratings.

### BACKGROUND OF THE INVENTION

1. Field of the Invention

The present invention relates to a spatial image display device, especially to a spatial color image display device.

2. Description of the Related Art

Please refer to FIG. 1, which illustrates an outline of a spatial image display device of prior art. As illustrated in FIG. 1, the spatial image display device is used to present a figure pattern (“ABC” as shown in the figure) to a viewer. The spatial image display device has a figure pattern layer 11 and a lenticular lens layer 12, wherein, the figure pattern layer 11 has a microminiature figure pattern (in the form of “ABC”) printed thereon using an ink or a pigment to prevent fake products, and the lenticular lens layer 12 has a plurality of lenticular lenses 121.

Without the lenticular lens layer 12 covering the figure pattern layer 11, a viewer cannot see the microminiature figure pattern on the figure pattern layer 11; and when the lenticular lens layer 12 is put on the figure pattern layer 11, an image enlargement effect will be provided to allow a viewer to clearly see the figure pattern appear below the lenticular lens layer 12.

However, it is difficult and costly to print the microminiature figure pattern on the figure pattern layer 11 using the ink or pigment.

To solve the foregoing problems, a novel spatial image display device is needed.

### SUMMARY OF THE INVENTION

One objective of the present invention is to disclose a spatial color image display device, which is capable of forming a microminiature figure pattern by a plurality of gratings.

Another objective of the present invention is to disclose a spatial color image display device, which is capable of displaying a figure pattern in different colors when viewed at different angles.

Still another objective of the present invention is to disclose a spatial color image display device, which is capable of preventing it from being copied.

To attain the foregoing objectives, a spatial color image display device is proposed, including:

a figure pattern layer, made of a transparent material and having at least one figure zone, each of the at least one figure zone being defined by an area of a geometric shape; and

a microlens layer, located above the figure pattern layer and having a first surface, a second surface, and a plurality of microlenses disposed two-dimensionally on the second surface, the first surface contacting the figure pattern layer, each of the microlenses having a cross section region on the second surface, and the cross section region being similar to the figure zone with a size ratio of 1:(n+r) or (n+r):1, n being a positive integer and 0<r<0.2 or −0.2<r<0;

wherein each of the at least one figure zone has therein a figure pattern formed by a plurality of gratings, so as to allow a viewer to see the figure pattern in different colors at different view angles.

In one embodiment, the geometric shape is a polygon with four sides.

In one embodiment, the geometric shape is a polygon with six sides.

In one embodiment, the geometric shape is a circle.

In one embodiment, the gratings are amplitude gratings.

In one embodiment, the gratings are phase gratings.

In one embodiment, the gratings are blazed gratings.

In one embodiment, the n is equal to 1.

In one embodiment, the figure pattern includes at least one character.

In one embodiment, the figure pattern includes at least one number.

In one embodiment, the figure pattern includes at least one symbol.

In one embodiment, the figure pattern includes at least one graphic representation.

In one embodiment, the figure pattern layer is made of a resin.

In one embodiment, the microlens layer is made of a resin.

In one embodiment, the spatial color image display device further includes a metal layer beneath the figure pattern layer.

In one embodiment, the spatial color image display device further includes a protective layer beneath the metal layer, the protective layer being made of a UV curing glue, a silicone glue, or a resin.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates an outline of a spatial image display device of prior art.

FIG. 2a illustrates an exploded view of a spatial color image display device according to an embodiment of the present invention.

FIG. 2b illustrates the gratings of FIG. 2a realized by phase gratings.

FIG. 2c illustrates the gratings of FIG. 2a realized by blazed gratings.

FIG. 3 illustrates an assembly diagram of the spatial color image display device of FIG. 2a.

FIG. 4a-4b illustrate an embodiment of the spatial color image display device of the present invention that uses a polygon with six sides as the shape of the microlens and is capable of allowing a viewer to see a figure pattern appear above the microlens layer in different colors at different view angles.

FIG. 5a-5b illustrate another embodiment of the spatial color image display device of the present invention that uses a polygon with six sides as the shape of the microlens and is capable of allowing a viewer to see a figure pattern appear below the microlens layer in different colors at different view angles.

FIG. 6a-6b illustrate an embodiment of the spatial color image display device of the present invention that uses a polygon with four sides as the shape of the microlens and is capable of allowing a viewer to see a figure pattern appear above the microlens layer in different colors at different view angles.

FIG. 7a-7b illustrate another embodiment of the spatial color image display device of the present invention that uses a polygon with four sides as the shape of the microlens and is capable of allowing a viewer to see a figure pattern appear below the microlens layer in different colors at different view angles.

FIG. 8a-8b illustrate an embodiment of the spatial color image display device of the present invention that uses a circle as the shape of the microlens and is capable of allowing a viewer to see a figure pattern appear above the microlens layer in different colors at different view angles.

FIG. 9a-9b illustrate another embodiment of the spatial color image display device of the present invention that uses a circle as the shape of the microlens and is capable of allowing a viewer to see a figure pattern appear below the microlens layer in different colors at different view angles.

FIG. 10 illustrates still another embodiment of the spatial color image display device of the present invention.

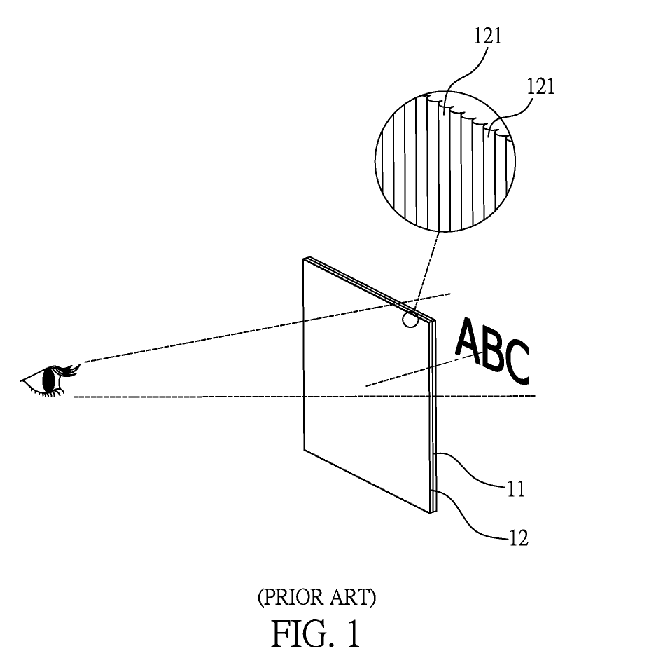

### DETAILED DESCRIPTION OF THE PREFERRED EMBODIMENTS

The present invention will be described in more detail hereinafter with reference to the accompanying drawings that show the preferred embodiments of the invention.

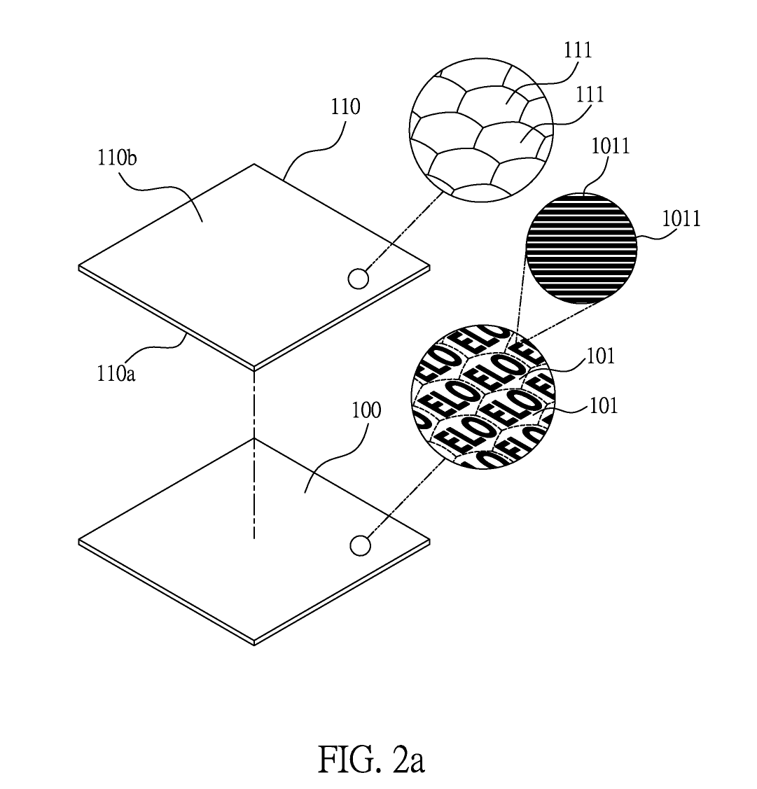

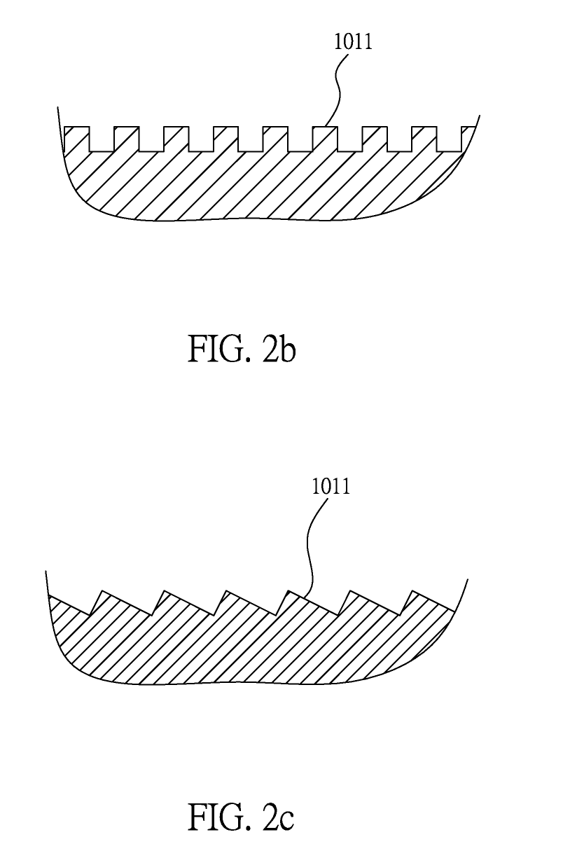

Please refer to FIG. 2a, which illustrates an exploded view of a spatial color image display device according to an embodiment of the present invention. As illustrated in FIG. 2a, the spatial color image display device includes a figure pattern layer 100 and a microlens layer 110.

The figure pattern layer 100 is made of a transparent material and has at least one figure zone 101, each of the at least one figure zone 101 being defined by an area of a geometric shape (e.g., a polygon with six sides as shown in FIG. 2a). The transparent material can be a resin, and each of the at least one figure zone 101 has therein a figure pattern (e.g., “ELO” as shown in FIG. 2a) formed by a plurality of gratings. That is, the present invention implements the figure pattern by a plurality of gratings 1011 formed within the area of the geometric shape of the figure pattern layer 100, and the gratings 1011 can be formed by a semiconductor manufacturing process or a laser process. Besides, the figure pattern can include at least one character (Chinese or English), at least one number, at least one symbol, at least one graphic representation, or any combination thereof.

Although the gratings 1011 shown in FIG. 2a are amplitude gratings, however, phase gratings as shown in FIG. 2b or blazed gratings as shown in FIG. 2c can also be used to provide a dispersion effect. When incident light is a composite light (e.g., white light), the gratings 1011 will split the composite light into monochromatic lights traveling toward different directions. Accordingly, the present invention can allow a viewer to see the figure pattern in different colors at different view angles.

The microlens layer 110 is located above the figure pattern layer 100 and has a first surface 110a, a second surface 110b, and a plurality of microlenses 111 disposed two-dimensionally on the second surface 110b. The first surface 110a contacts the figure pattern layer 100, and each of the microlenses 111 has a cross section region on the second surface 110a. The cross section region is similar to the figure zone 101 with a size ratio of 1:(n+r) or (n+r):1, n being a positive integer and 0<r<0.2 or −0.2<r<0.

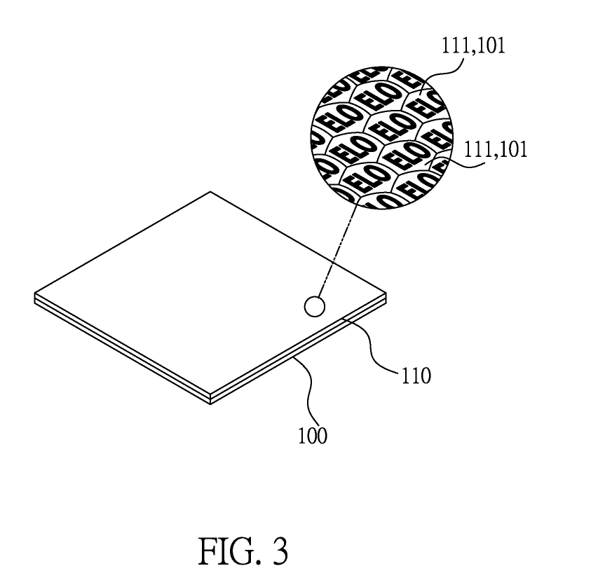

When designed within the range of the size ratio, the microlens layer 110 and the figure pattern layer 100 can be combined (please refer to FIG. 3, which illustrates an assembly diagram of the spatial color image display device of FIG. 2a) to provide a “spatial beat” effect, so as to display an enlarged image of the figure pattern above or below the microlens layer 110. As the principle of the “spatial beat” is already known in the field of optics, it will not be addressed further.

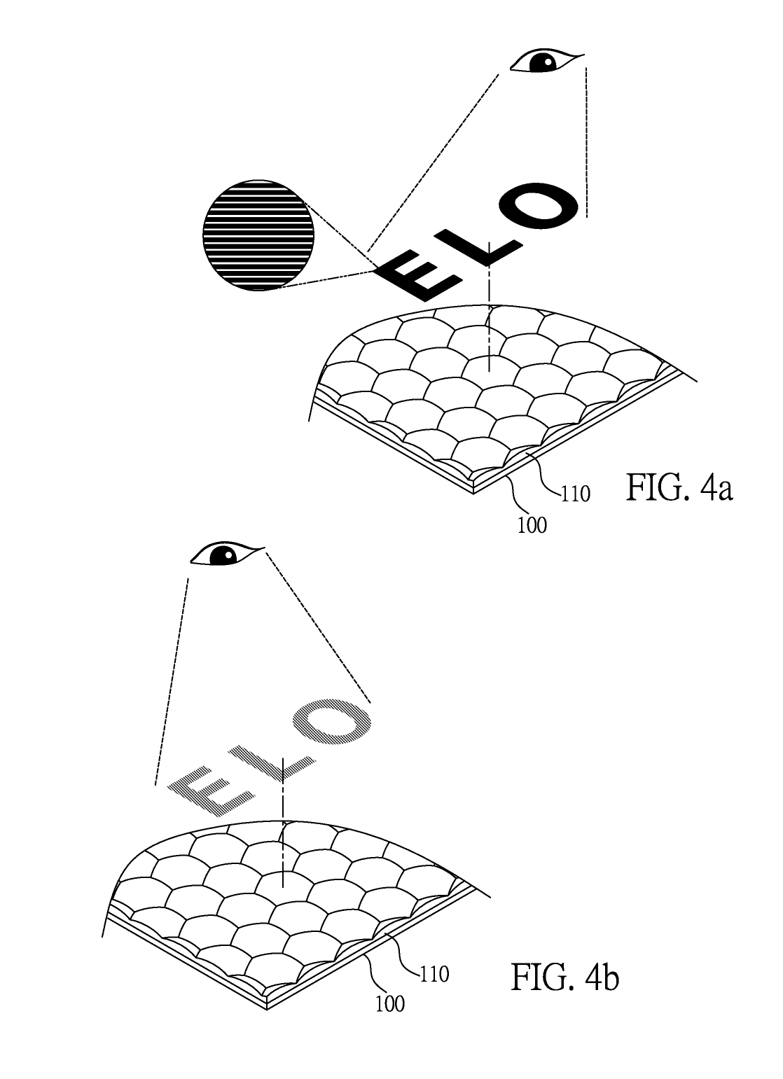

Please refer to FIG. 4a and FIG. 4b, which illustrate the spatial color image display device of FIG. 2a designed according to a value within the range of the size ratio, so as to allow a viewer to see a figure pattern appear above the microlens layer 110 in different colors at different view angles.

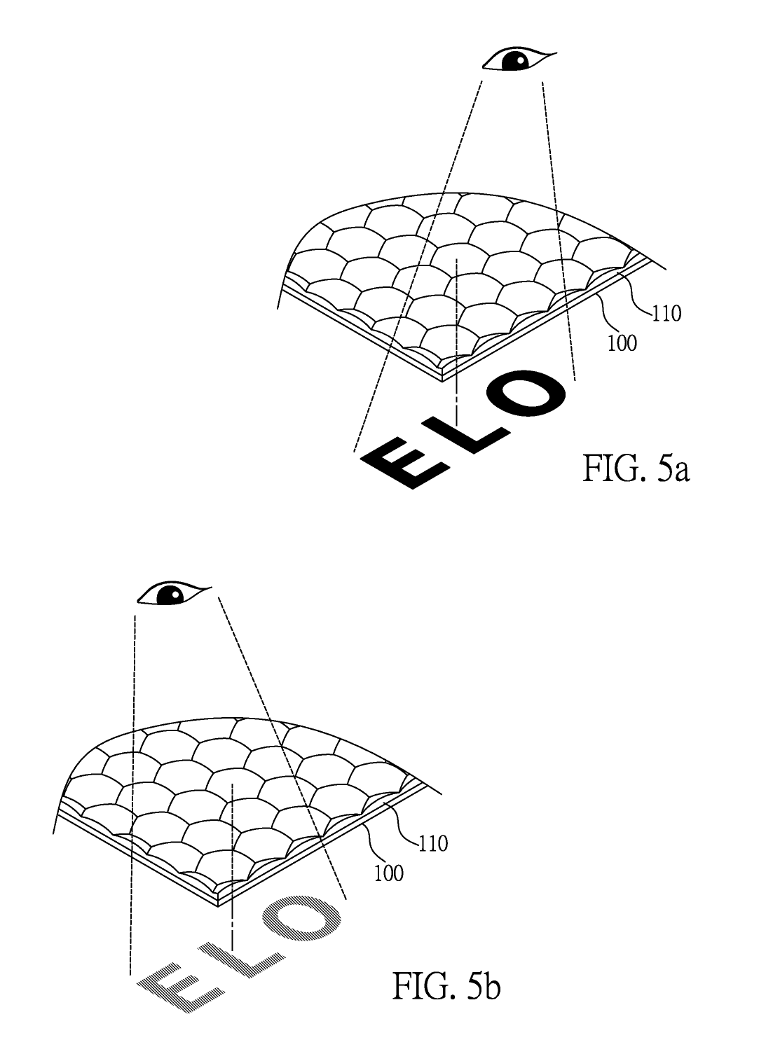

Please refer to FIG. 5a and FIG. 5b, which illustrate the spatial color image display device of FIG. 2a designed according to another value within the range of the size ratio, so as to allow a viewer to see a figure pattern appear below the microlens layer 110 in different colors at different view angles.

In addition, the geometric shape can also be other shapes like a polygon with four sides or a circle.

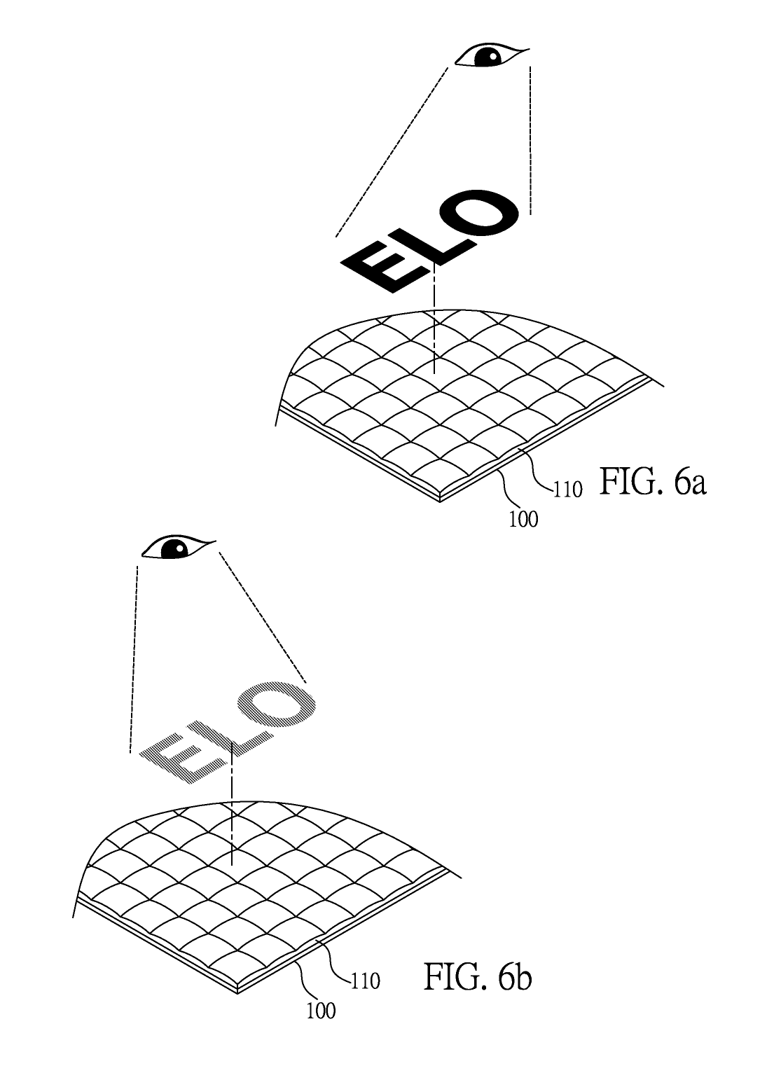

Please refer to FIG. 6a and FIG. 6b, which illustrate the spatial color image display device of the present invention using a polygon with four sides as the geometric shape, and the size ratio is set to allow a viewer to see a figure pattern appear above the microlens layer 110 in different colors at different view angles.

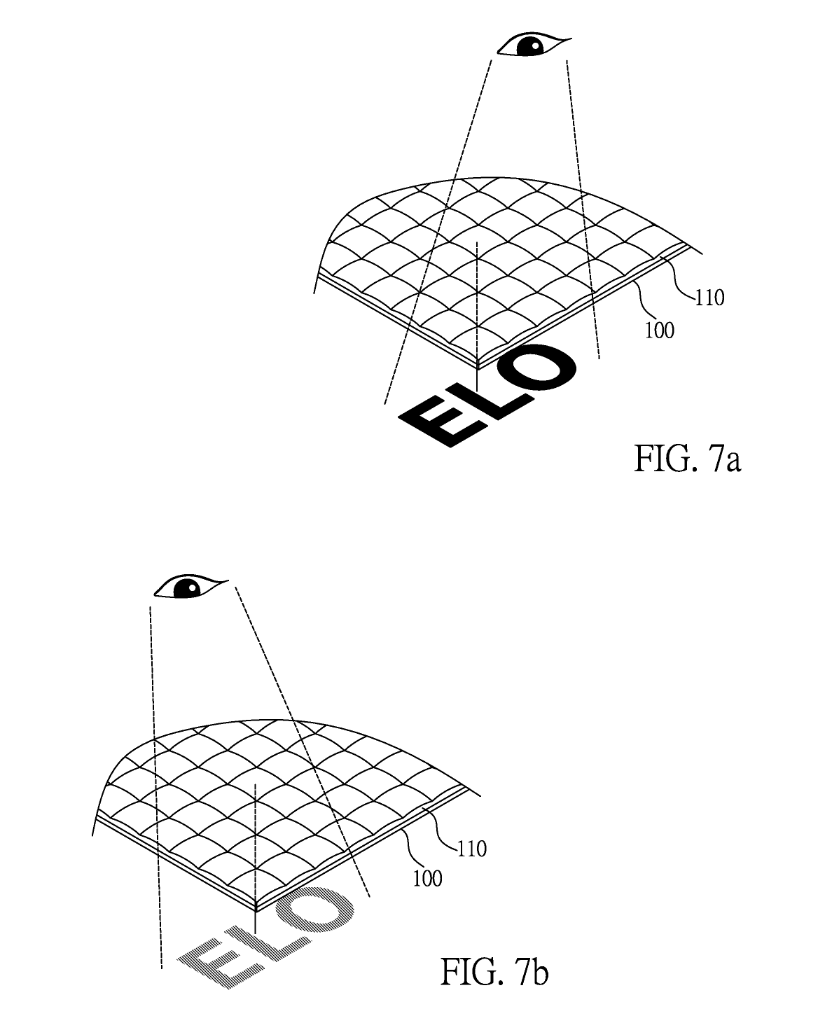

Please refer to FIG. 7a and FIG. 7b, which illustrate the spatial color image display device of the present invention using a polygon with four sides as the geometric shape, and the size ratio is set to allow a viewer to see a figure pattern appear below the microlens layer 110 in different colors at different view angles.

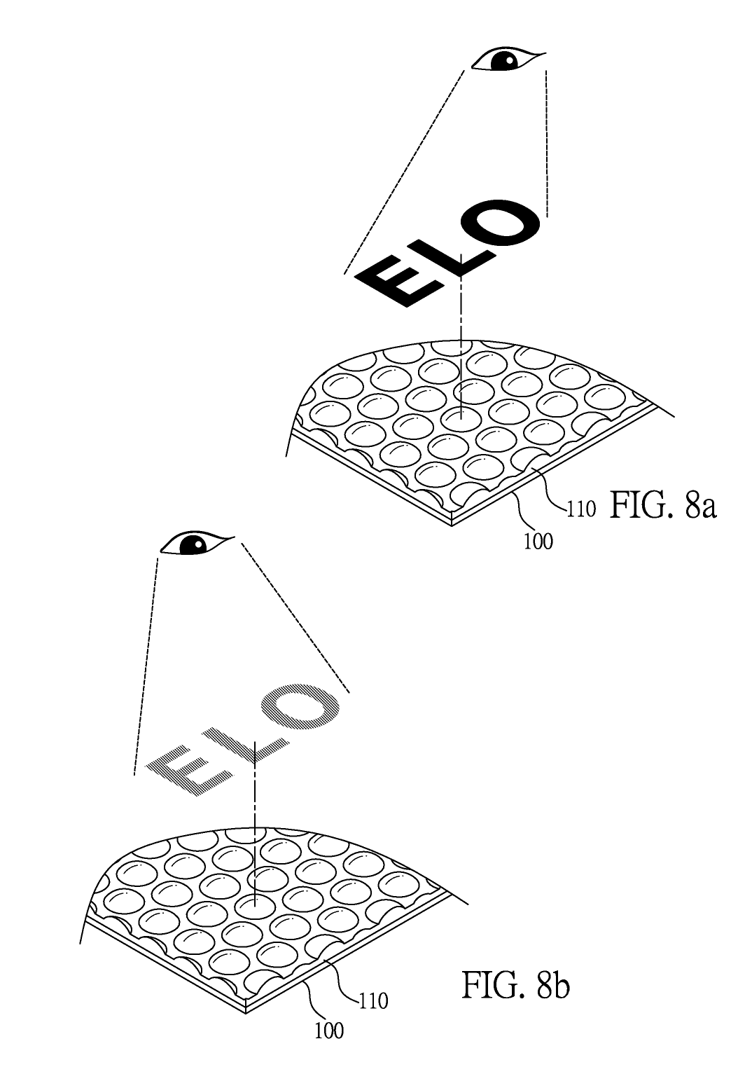

Please refer to FIG. 8a and FIG. 8b, which illustrate the spatial color image display device of the present invention using a circle as the geometric shape, and the size ratio is set to allow a viewer to see a figure pattern appear above the microlens layer 110 in different colors at different view angles.

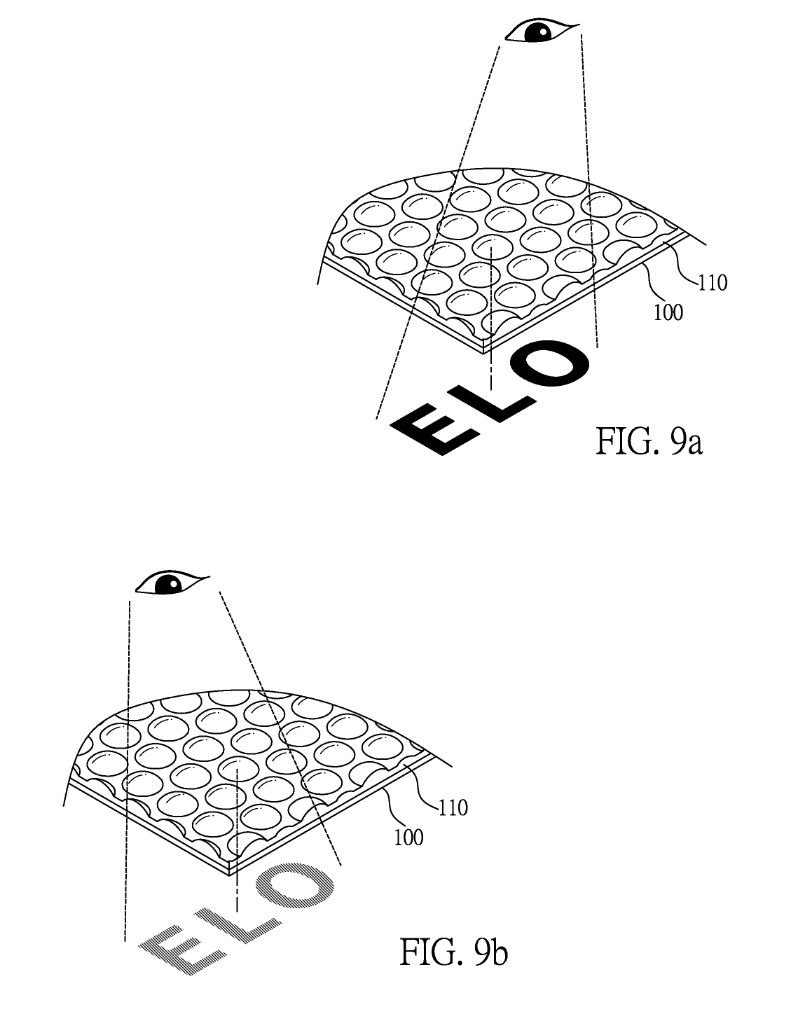

Please refer to FIG. 9a and FIG. 9b, which illustrate the spatial color image display device of the present invention using a circle as the geometric shape, and the size ratio is set to allow a viewer to see a figure pattern appear below the microlens layer 110 in different colors at different view angles.

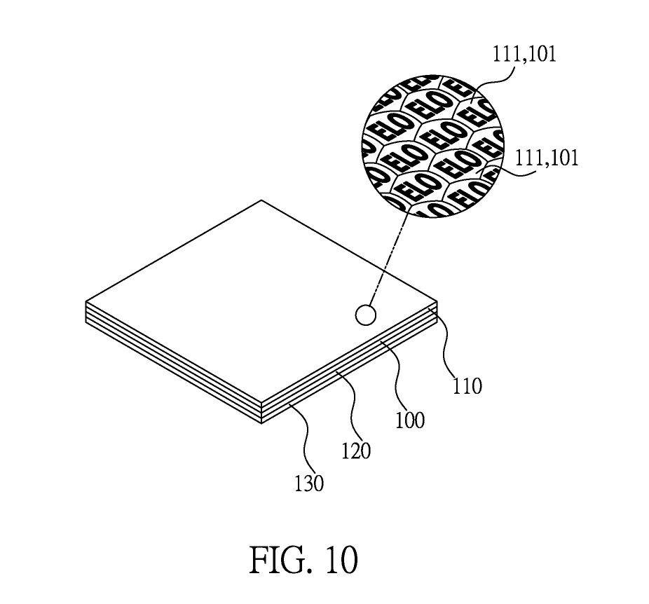

Besides, the spatial color image display device of the present invention can further include a metal layer to provide a reflection effect or a transmission-reflection effect (depending on the thickness of the metal layer). Please refer to FIG. 10, which illustrates another embodiment of the spatial color image display device of the present invention. As illustrated in FIG. 10, the spatial color image display device has a metal layer 120 attached beneath the figure pattern layer 100, and a protective layer 130 beneath the metal layer 120, wherein the protective layer 130 can be made of a UV (ultraviolet) curing glue, a silicone glue, or a resin.

Thanks to the designs proposed above, the present invention can offer the advantages as follows:

1. The spatial color image display device of the present invention is capable of forming a microminiature figure pattern by a plurality of gratings.

2. The spatial color image display device of the present invention is capable of displaying a figure pattern in different colors when viewed at different angles.

3. The spatial color image display device of the present invention is capable of preventing it from being copied.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A spatial color image display device, including:
a figure pattern layer, made of a transparent material and having at least one figure zone, each of the at least one figure zone being defined by an area of a geometric shape; and
a microlens layer, located above the figure pattern layer and having a first surface, a second surface, and a plurality of microlenses disposed two-dimensionally on the second surface, the first surface contacting the figure pattern layer, each of the microlenses having a cross section region on the second surface, and the cross section region being similar to the figure zone with a size ratio of 1:(n+r) or (n+r):1, n being a positive integer and 0<r<0.2 or −0.2<r<0;
wherein each of the at least one figure zone has therein a figure pattern formed by a plurality of gratings, so as to allow a viewer to see the figure pattern in different colors at different view angles.

2. The spatial color image display device as disclosed in claim 1, wherein the geometric shape is selected from a group consisting of a polygon with four sides, a polygon with six sides, and a circle.

3. The spatial color image display device as disclosed in claim 1, wherein the gratings are amplitude gratings.

4. The spatial color image display device as disclosed in claim 1, wherein the gratings are phase gratings or blazed gratings.

5. The spatial color image display device as disclosed in claim 1, wherein the n is equal to 1.

6. The spatial color image display device as disclosed in claim 1, wherein the figure pattern includes an element selected from a group consisting of at least one character, at least one number, at least one symbol, at least one graphic representation, and any combination thereof.

7. The spatial color image display device as disclosed in claim 1, wherein the figure pattern layer is made of a resin.

8. The spatial color image display device as disclosed in claim 1, wherein the microlens layer is made of a resin.

9. The spatial color image display device as disclosed in claim 1, further including a metal layer beneath the figure pattern layer.

10. The spatial color image display device as disclosed in claim 1, further including a protective layer beneath the metal layer, the protective layer being made of a material selected from a group consisting of a UV curing glue, a silicone glue, and a resin.
